(19) United States
(12) Patent Application Publication
(10) Pub. No.: US 2010/0135326 A1
(43) Pub. Date: Jun. 3, 2010

(54) TECHNIQUE FOR BUNDLE CREATION

(75) Inventors: Siddharth Ray, Bridgewater, NJ (US); Ashwin Sampath, Skillman, NJ (US); Shailesh Maheshwari, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/620,504

(22) Filed: Nov. 17, 2009

Related U.S. Application Data
(60) Provisional application No. 61/116,984, filed on Nov. 21, 2008.

(51) Int. Cl. H04J 3/24

(52) U.S. Cl. 370/474

(57) ABSTRACT

Systems and methodologies are described that facilitate creating a packet bundle of Internet Protocol (IP) packets that can be utilized for Just-In-Time (JIT) processing and/or offline processing. In general, upon receipt or detection of incoming IP packets, two or more IP packets can be bundled or packaged together to create a packet bundle. Furthermore, the packet bundle can be created based upon a timer in which a maximum size of the packet bundle and a maximum number of IP packets within a packet bundle can be maintained.

### CROSS-REFERENCE TO RELATED APPLICATIONS

This application claims the benefit of U.S. Provisional Patent application Ser. No. 61/116,984 entitled “POWER HEADROOM SENSITIVE SCHEDULING” which was filed Nov. 21, 2008. The entirety of the aforementioned application is herein incorporated by reference.

### BACKGROUND

I. Field

The following description relates generally to wireless communications, and more particularly to mitigating Just-In-Time (JIT) processing for Internet Protocol (IP) packets.

II. Background

Wireless communication systems are widely deployed to provide various types of communication; for instance, voice and/or data can be provided via such wireless communication systems. A typical wireless communication system, or network, can provide multiple users access to one or more shared resources (e.g., bandwidth, transmit power, . . . ). For instance, a system can use a variety of multiple access techniques such as Frequency Division Multiplexing (FDM), Time Division Multiplexing (TDM), Code Division Multiplexing (CDM), Orthogonal Frequency Division Multiplexing (OFDM), and others.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations.

Wireless communication systems oftentimes employ one or more base stations that provide a coverage area. A typical base station can transmit multiple data streams for broadcast, multicast and/or unicast services, wherein a data stream may be a stream of data that can be of independent reception interest to a mobile device. A mobile device within the coverage area of such base station can be employed to receive one, more than one, or all the data streams carried by the composite stream. Likewise, a mobile device can transmit data to the base station or another mobile device.

Typically within the Long Term Evolution (LTE) Air Interface, Internet Protocol (IP) packets are received individually and subsequently processed individually. For instance, a first IP packet can be received in which Just-In-Time (JIT) processing can be employed immediately on the first IP packet. However, with a large increase of IP packets and/or an overload of IP packets within the LTE Air Interface, the JIT processing can be extremely intensive.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to related aspects, a method that facilitates generating a packet bundle with two or more IP packets. The method can include receiving an Internet Protocol (IP) packet. Further, the method can include generating a packet bundle that includes two or more IP packets. Moreover, the method can comprise employing at least one of a Just-In-Time (JIT) processing on the packet bundle or an offline processing on the packet bundle.

Another aspect relates to a wireless communications apparatus. The wireless communications apparatus can include at least one processor configured to receive an Internet Protocol (IP) packet, generate a packet bundle that includes two or more IP packets, and employ at least one of a Just-In-Time (JIT) processing on the packet bundle or an offline processing on the packet bundle. Further, the wireless communications apparatus can include memory coupled to the at least one processor.

Yet another aspect relates to a wireless communications apparatus that enables bundling IP packets for optimized JIT processing. The wireless communications apparatus can include means for receiving an Internet Protocol (IP) packet. Additionally, the wireless communications apparatus can comprise means for generating a packet bundle that includes two or more IP packets. Further, the wireless communications apparatus can comprise means for employing at least one of a Just-In-Time (JIT) processing on the packet bundle or an offline processing on the packet bundle.

Still another aspect relates to a computer program product comprising a computer-readable medium having stored thereon code causing at least one computer to receive an Internet Protocol (IP) packet, generate a packet bundle that includes two or more IP packets, and employ at least one of a Just-In-Time (JIT) processing on the packet bundle or an offline processing on the packet bundle.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example communications apparatus for employment within a wireless communications environment.

FIG. 3 is an illustration of an example wireless communications system that facilitates bundling IP packets for optimized JIT processing.

FIG. 4 is an illustration of an example system that facilitates generating a packet bundle with two or more IP packets.

FIG. 5 is an illustration of an example methodology that facilitates packaging IP packets into a packet bundle within a user equipment.

FIG. 6 is an illustration of an example methodology that facilitates identifying IP packets from a base station to bundle based at least in part upon a timer.

FIG. 7 is an illustration of an example mobile device that facilitates creating a packet bundle of two or more IP packets in a wireless communication system.

FIG. 8 is an illustration of an example system that facilitates employing bundle creation within a wireless communication environment.

FIG. 9 is an illustration of an example wireless network environment that can be employed in conjunction with the various systems and methods described herein.

FIG. 10 is an illustration of an example system that facilitates packaging IP packets into a packet bundle within a user equipment.

FIG. 11 is an illustration of an example system that identifies IP packets from a base station to bundle based at least in part upon a timer in a wireless communication environment.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, an eNodeB, or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

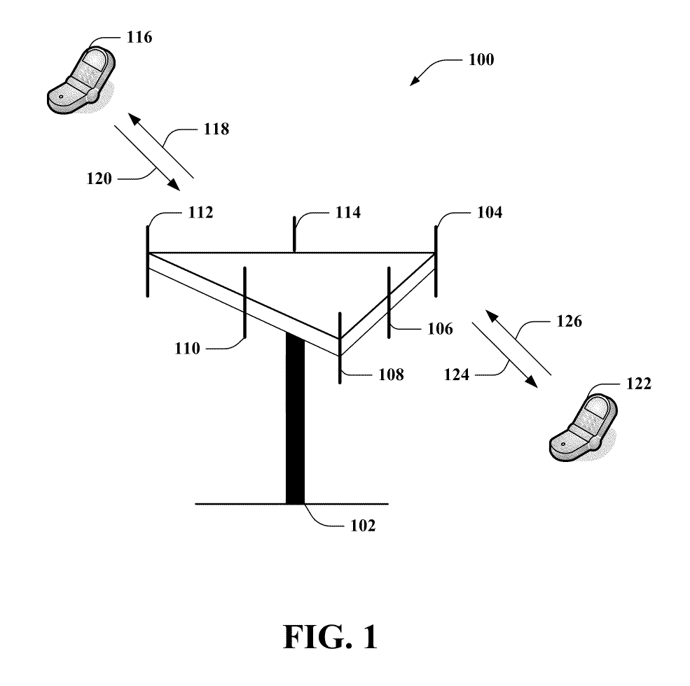

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices.

Base station 102 (and/or each sector of base station 102) can employ one or more multiple access technologies (e.g., CDMA, TDMA, FDMA, OFDMA, . . . ). For instance, base station 102 can utilize a particular technology for communicating with mobile devices (e.g., mobile devices 116 and 122) upon a corresponding bandwidth. Moreover, if more than one technology is employed by base station 102, each technology can be associated with a respective bandwidth. The technologies described herein can include following: Global System for Mobile (GSM), General Packet Radio Service (GPRS), Enhanced Data Rates for GSM Evolution (EDGE), Universal Mobile Telecommunications System (UMTS), Wideband Code Division Multiple Access (W-CDMA), cdmaOne (IS-95), CDMA2000, Evolution-Data Optimized (EV-DO), Ultra Mobile Broadband (UMB), Worldwide Interoperability for Microwave Access (WiMAX), MediaFLO, Digital Multimedia Broadcasting (DMB), Digital Video Broadcasting—Handheld (DVB-H), etc. It is to be appreciated that the aforementioned listing of technologies is provided as an example and the claimed subject matter is not so limited; rather, substantially any wireless communication technology is intended to fall within the scope of the hereto appended claims.

Base station 102 can employ a first bandwidth with a first technology. Moreover, base station 102 can transmit a pilot corresponding to the first technology on a second bandwidth. According to an illustration, the second bandwidth can be leveraged by base station 102 and/or any disparate base station (not shown) for communication that utilizes any second technology. Moreover, the pilot can indicate the presence of the first technology (e.g., to a mobile device communicating via the second technology). For example, the pilot can use bit(s) to carry information about the presence of the first technology. Additionally, information such as a SectorID of the sector utilizing the first technology, a Carrierindex indicating the first frequency bandwidth, and the like can be included in the pilot.

According to another example, the pilot can be a beacon (and/or a sequence of beacons). A beacon can be an OFDM symbol where a large fraction of the power is transmitted on one subcarrier or a few subcarriers (e.g., small number of subcarriers). Thus, the beacon provides a strong peak that can be observed by mobile devices, while interfering with data on a narrow portion of bandwidth (e.g., the remainder of the bandwidth can be unaffected by the beacon). Following this example, a first sector can communicate via CDMA on a first bandwidth and a second sector can communicate via OFDM on a second bandwidth. Accordingly, the first sector can signify the availability of CDMA on the first bandwidth (e.g., to mobile device(s) operating utilizing OFDM on the second bandwidth) by transmitting an OFDM beacon (or a sequence of OFDM beacons) upon the second bandwidth.

The subject innovation can collect and bundle Internet Protocol (IP) packets into a packet bundle based upon at least one of a timer, a maximum size of the packet bundle, and/or a maximum number of IP packets within the packet bundle. Once the packet bundle is created, the packet bundle can be communicated for Just-In-Time (JIT) processing and/or offline processing. By creating the packet bundle (e.g., collection of two or more IP packets), the subject innovation can optimize JIT processing. In particular, the packet bundle can be creating during a start of a timer or during a time interval. At the expiration of the timer or the time interval, the packet bundle can be conveyed for JIT processing. Moreover, the packet bundle can be conveyed if a maximum size of the packet bundle is reached and/or a maximum number of IP packets are bundled within the packet bundle. Furthermore, the technique of bundle creation or creating the packet bundle can be implemented in any suitable LTE Air Interface layer (e.g., LTE interface layer) such as, but not limited to, Packet Data Convergence Procotol (PDCP) layer, Medium Access Control (MAC) layer, Radio Link Control (RLC) layer, etc.

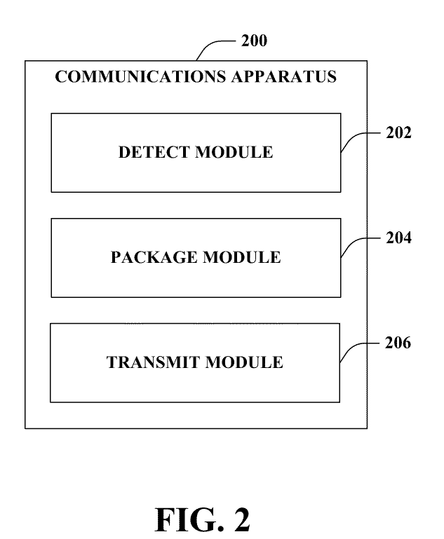

Turning to FIG. 2, illustrated is a communications apparatus 200 for employment within a wireless communications environment. The communications apparatus 200 can be a base station or a portion thereof, a mobile device or a portion thereof, a network or a portion thereof, or substantially any communications apparatus that receives data transmitted in a wireless communications environment. In communications systems, the communications apparatus 200 employ components described below to package, collect, gather, or bundle IP packets together (e.g., two or more IP packets to create a packet bundle).

The communications apparatus 200 can include a detect module 202 that can identify receipt of an IP packet. It is to be appreciated that the receipt of the IP packet can be from at least one of a user equipment or a base station. Moreover, the IP packet can be, for instance, a PDCP Service Data Unite (SDU)—yet based on the layer in which the packet bundle is created, the IP packet can be any suitable portion of data.

The communications apparatus 200 can further include a package module 204 that can create a packet bundle that includes two or more IP packets. The package module 204 can initiate the collection and/or gathering of IP packets to create the packet bundle based at least in part upon the detection of receipt of an IP packet. Moreover, the package module 204 can create the packet bundle based upon at least one of a timer, a maximum size of the packet bundle, and/or a maximum number of IP packets within a packet bundle. Upon creation of the packet bundle or detecting a trigger (e.g., a timer, a maximum size of the packet bundle, a maximum number of IP packets, etc.), the communications apparatus 200 can leverage a transmit module 206 that can communicate the packet bundle for JIT processing and/or offline processing.

For example, the packet bundle can be created or generated based upon a timer or a time interval. Upon detection of the receipt of an IP packet, the timer can be started and/or the time interval can begin. During the timer or the time interval, the packet bundle can be created by bundling IP packets. Upon expiration of the timer or the time interval, the creation of the packet bundle can be complete and the packet bundle can be conveyed or communicated for JIT processing and/or offline processing.

In another example, the packet bundle can be created based upon a maximum size of the packet bundle. In other words, the packet bundle can have a maximum size that when reached, can trigger the packet bundle to be communicated to for JIT processing and/or offline processing. It is to be appreciated that the maximum size of the packet bundle can be employed with the timer or time interval, and/or the maximum number of IP packets (discussed below).

In yet another example, the packet bundle can be generated based upon a maximum number of IP packets. In other words, the packet bundle can include a limit on a number of IP packets within each packet bundle. Upon meeting the maximum number of IP packets, the packet bundle can be communicated for JIT processing. For instance, if the maximum number of IP packets is 100, then when 100 IP packets is met, the packet bundle can be conveyed for JIT processing (if the timer or time period is not yet expired). Moreover, it is to be appreciated that the maximum number of IP packets can be employed with the timer or time interval, and/or the maximum size of the packet bundle. Additionally, it is to be appreciated that the bundle creation can implement at least one of a timer, maximum size of the packet bundle, and/or the maximum number of IP packets.

Moreover, although not shown, it is to be appreciated that communications apparatus 200 can include memory that retains instructions with respect to receiving an Internet Protocol (IP) packet, generating a packet bundle within a user equipment that includes two or more IP packets, employing Just-In-Time (JIT) processing on the packet bundle, and the like. Further, communications apparatus 200 can include a processor that may be utilized in connection with executing instructions (e.g., instructions retained within memory, instructions obtained from a disparate source, . . . ).

Additionally, although not shown, it is to be appreciated that communications apparatus 200 can include memory that retains instructions with respect to receiving an Internet Protocol (IP) packet from a base station, generating a packet bundle that includes two or more IP packets, employing Just-In-Time (JIT) processing on the packet bundle, and the like. Further, communications apparatus 200 can include a processor that may be utilized in connection with executing instructions (e.g., instructions retained within memory, instructions obtained from a disparate source, . . . ).

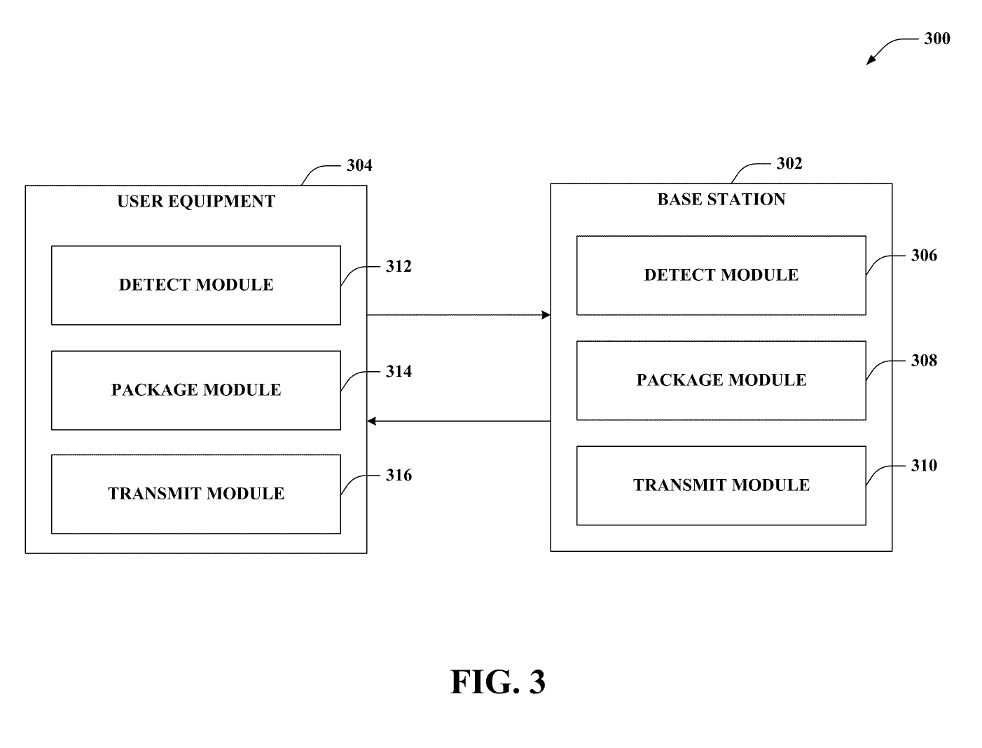

Now referring to FIG. 3, illustrated is a wireless communications system 300 that can bundle IP packets for optimized JIT processing. The system 300 includes a base station 302 that communicates with a user equipment 304 (and/or any number of disparate user equipment (not shown)). Base station 302 can transmit information to user equipment 304 over a forward link channel; further base station 302 can receive information from user equipment 304 over a reverse link channel. Moreover, system 300 can be a MIMO system. Additionally, the system 300 can operate in an OFDMA wireless network, a 3GPP LTE wireless network, etc. Also, the components and functionalities shown and described below in the base station 302 can be present in the mobile device 304 as well and vice versa, in one example; the configuration depicted excludes these components for ease of explanation. It is to be appreciated that system 300 can provide the creation of packet bundle(s) in which the creation can be within the base station 302 and/or the user equipment 304.

Base station 302 includes a detect module 306 that can detect or identify a receipt of an IP packet. The base station 302 can include a package module 308 that can create an IP packet bundle or packet bundle that includes two or more IP packets. It is to be appreciated that the package module 308 can initiate creation of the packet bundle based upon the receipt of the IP packet. Moreover, the package module 308 can implement a timer, a maximum size of the packet bundle, and/or a maximum number of IP packets within a packet bundle. The base station 302 can further include a transmit module 310 that can convey the packet bundle for JIT processing. It is to be appreciated that the transmit module 310 can further provide offline processing.

User equipment 304 can include a detect module 312 that can identify receipt of an IP packet. The user equipment 304 can further include a package module 314 that can create packet bundle that includes two or more IP packets based upon the receipt of an IP packet. Moreover, the package module 314 can create the packet bundle and include IP packets into the packet bundle for a length of time (e.g., timer, time interval, etc.). The package module 314 can further create the packet bundle based upon a maximum size of the packet bundle and/or a maximum number of IP packets within the packet bundle. The user equipment 304 can further include a transmit module 316 that can convey the packet bundle for JIT processing and/or offline processing.

Moreover, although not shown, it is to be appreciated that base station 302 can include memory that retains instructions with respect to receiving an Internet Protocol (IP) packet, generating a packet bundle within a user equipment that includes two or more IP packets, employing Just-In-Time (JIT) processing on the packet bundle, and the like. Further, base station 302 can include a processor that may be utilized in connection with executing instructions (e.g., instructions retained within memory, instructions obtained from a disparate source, . . . ).

Additionally, although not shown, it is to be appreciated that base station 302 can include memory that retains instructions with respect to receiving an Internet Protocol (IP) packet from a base station, generating a packet bundle that includes two or more IP packets, employing Just-In-Time (JIT) processing on the packet bundle, and the like. Further, base station 302 can include a processor that may be utilized in connection with executing instructions (e.g., instructions retained within memory, instructions obtained from a disparate source, . . . ).

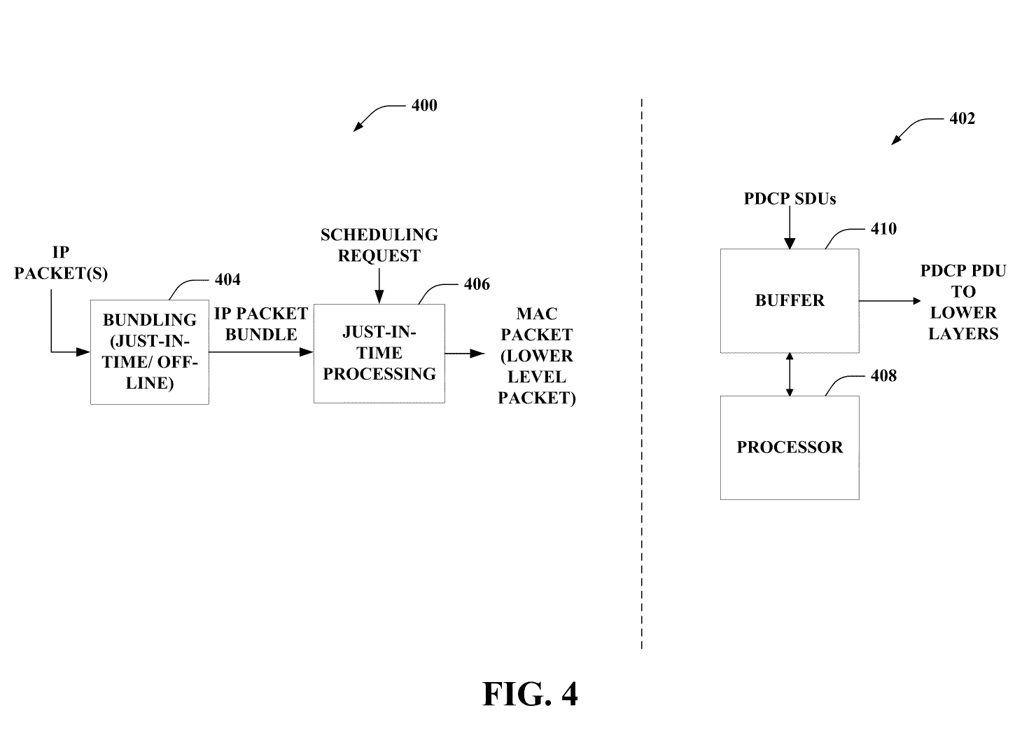

Now referring to FIG. 4, an example wireless communications system 400 and 402 can generate a packet bundle with two or more IP packets. The subject innovation relates to packet bundling at a layer (e.g., PDCP, MAC, RLC, etc.). The following can be employed with the subject innovation: creation of a bundle of IP packets (e.g., PDCP SDUs); and Sequence Number (SN) (e.g., PDCP, MAC, RLC, etc.) generation and ciphering with possibly header compression. This can be done just-in-time (JIT) or offline. Algorithms for the above that are adapted to the bundling technique can also be employed.

The system 400 can create a bundle of IP packets (e.g., PDCP SDUs, etc.) also referred to as a packet bundle. It is to be appreciated that this can be done JIT as well as offline. The system 400 can include a bundling 404 and a Just-In-Time processing 406. IP packets can be received by the bundling 404 which can provide the packaging of the IP packets in JIT or off-line. The IP packet bundle (e.g., packet bundle) can be communicated or conveyed to the JIT processing 406. Based upon a scheduling request, the JIT processing 406 can provide a lower level packet. In the example of the bundle creation being within the PDCP layer, the JIT processing 406 can provide a MAC packet.

The system 400 can include the following: a bundling timer that describes the time duration during which incoming IP packets are bundled; a maximum number of packets within a bundle that is the maximum number of SDUs in the bundle; a maximum bundle size that is the maximum size of the bundle, and a Just-in-time (JIT) processing that can create a lower level packet upon receipt of a scheduling request.

It is to be appreciated that the following is a brief description of packaging IP packets into a packet bundle within a PDCP layer. Yet, it is to be appreciated that the packaging of IP packets or the bundle creation can be within any layer with LTE and the following description is not limiting on the subject claims. The system 400 can bundle packets arriving at the PDCP layer during a certain time interval. While bundling, there may also be a limit on the number of PDCP SDUs in the bundle and size of the bundle (bytes). Besides decreasing implementation complexity, these limits may also ensure that Quality of Service (QoS) for the flow does not deteriorate. Not that these limits are soft limits, e.g., PDCP can select to not implement such limits.

When bundling is done off-line, a bundling timer can be started upon receipt of the first PDCP SDU and bundle all PDCP SDUs until the timer expires or the number of SDUs or size limitation is reached. If bundling is terminated due to the bundle limits being reached, the last PDCP SDU can either be included in the current bundle or pushed into the next bundle. The bundle is then processed (e.g., PDCP SN generation, ciphering with possibly header compression) before being sent to the lower layers.

After a bundle is created, the bundling timer can start again with the arrival of the next PDCP SDU. Note that the number of packets bundled can be directly proportional to the packet arrival rate and the length of the bundling timer.

Additionally, there can be stimuli that can be used for aborting or enabling bundling. For example, buffer level for packets in just-in-time processing queue can be utilized. When these input buffers are not sufficiently filled, bundling can be aborted. Otherwise, this can affect the QoS for that IP flow. Additionally, MIPS limitation in Just-in-time processing can be utilized. When there is a MIPS limitation in the just-in-time processing, bundling can be enabled or increased to decrease the effective packet rate.

Turning to the system 402, the PDCP layer on the transmit side receives one or more PDCP SDUs from upper layers. The PDCP layer processes the PDCP SDUs to form a single PDCP PDU that is submitted to lower layers for transmission. The mapping between PDCP SDUs and PDCP PDUs is many-to-one, e.g., every PDCP PDU is formed from 2 or more PDCP SDUs. This bundling of multiple PDCP SDUs into a single PDCP PDU can be done prior to, after, or in between the transmit PDCP processing operations.

On the receive side, the PDCP layer processes the PDCP PDUs to extract the underlying PDCP SDUs which are then submitted to the upper layers. The mapping between PDCP SDUs and PDCP PDUs is many-to-one, e.g., 1 or more PDCP SDUs are extracted from every PDCP PDU. This unbundling of multiple PDCP SDUs from a single PDCP PDU can be done prior to, after or in between the receive PDCP processing operations.

The process of bundling PDCP SDUs can be done just-in-time as well as offline. In an embodiment, packets arriving at the PDCP layer are bundled during a certain time interval. While bundling, there may also be a limit on the number of PDCP SDUs in the bundle and size of the bundle (bytes). Besides decreasing implementation complexity, these limits may also ensure that a Quality of Service (QoS) for the flow does not deteriorate. In one embodiment, the limits are soft limits, e.g., one or both limits (number of SDUs and bundle size) may be optionally used.

In an embodiment, for example when bundling is done off-line, a bundling timer may be started upon receipt of a first PDCP SDU. As further PDCP SDUs are received, they are bundled with previously received PDCP SDUs until the timer expires, a maximum number of PDCP SDUs is reached, or a size limitation, typically expressed as bits or bytes, is reached. If bundling is terminated due to bundle limits being reached, the last PDCP SDU can either be included in the current bundle or pushed into the next bundle. The bundle is then processed (PDCP SN generation, ciphering with possibly header compression) by a processor 408 before being sent to lower layers. After a bundle is created, the bundling timer starts once again with the arrival of the next PDCP SDU.

In one embodiment, bundling may be aborted if the number of PDCP SDUs stored in a buffer is less than a predetermined threshold. A buffer 410 may be used in the case of a just-in-time case of bundling, where packets are accumulated in a buffer and then bundled when the number of PDCP SDUs reaches a predetermined threshold or when a predetermined amount of data is present. In another embodiment, if there is a MIPS limitation in the just-in-time processing steps, bundling can be enabled or increased to decrease the effective packet rate.

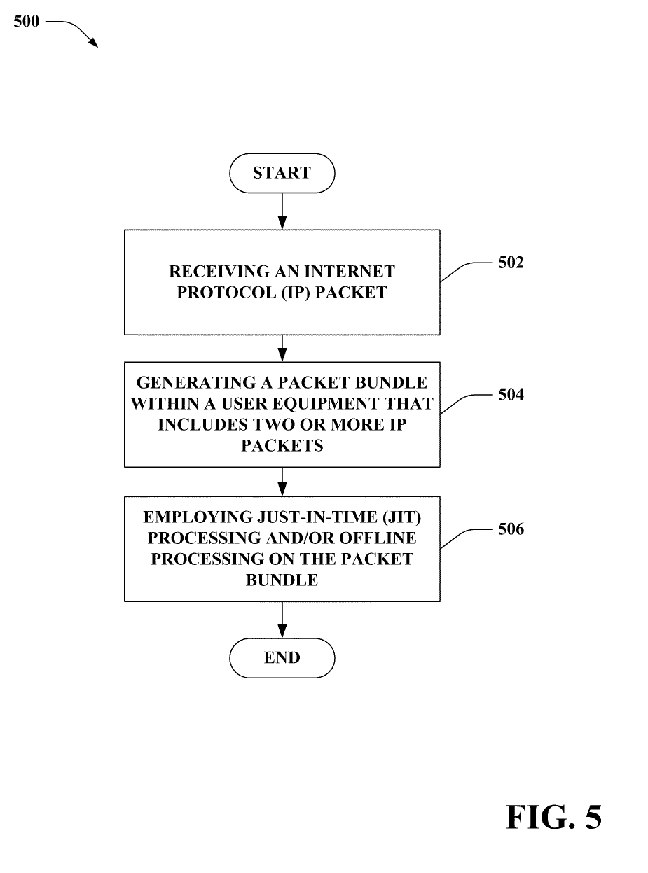

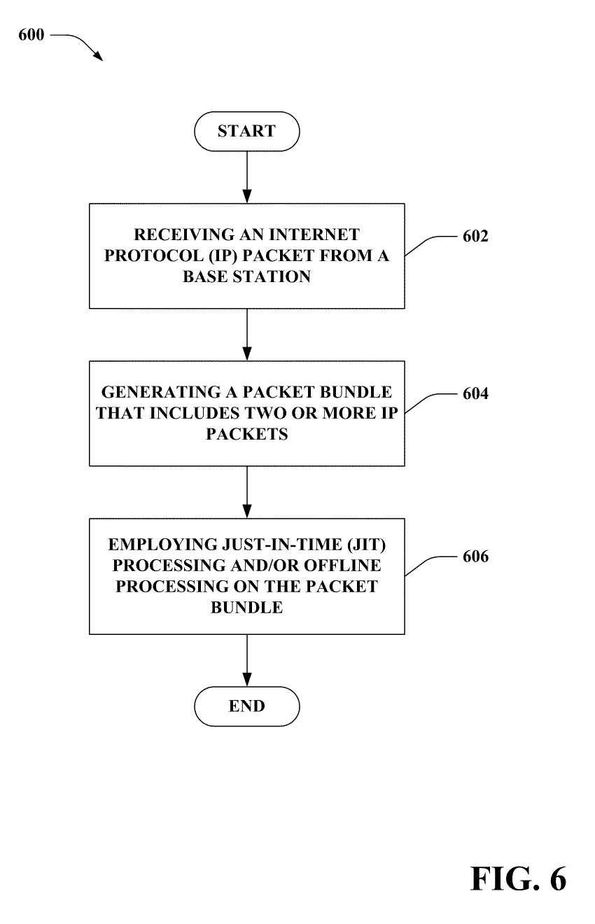

Referring to FIGS. 5-6, methodologies relating to IP packet bundle creation are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 5, illustrated is a methodology 500 that facilitates packaging IP packets into a packet bundle within a user equipment. At reference numeral 502, an Internet Protocol (IP) packet can be received. At reference numeral 504, a packet bundle within a user equipment that includes two or more IP packets can be generated. At reference numeral 506, Just-In-Time (JIT) processing and/or offline processing on the packet bundle can be employed.

Now referring to FIG. 6, a methodology 600 that facilitates identifying IP packets from a base station to bundle based at least in part upon a timer. At reference numeral 602, an Internet Protocol (IP) packet from a base station can be received. At reference numeral 604, a packet bundle that includes two or more IP packets can be generated. At reference numeral 606, Just-In-Time (JIT) processing and/or offline processing on the packet bundle can be employed.

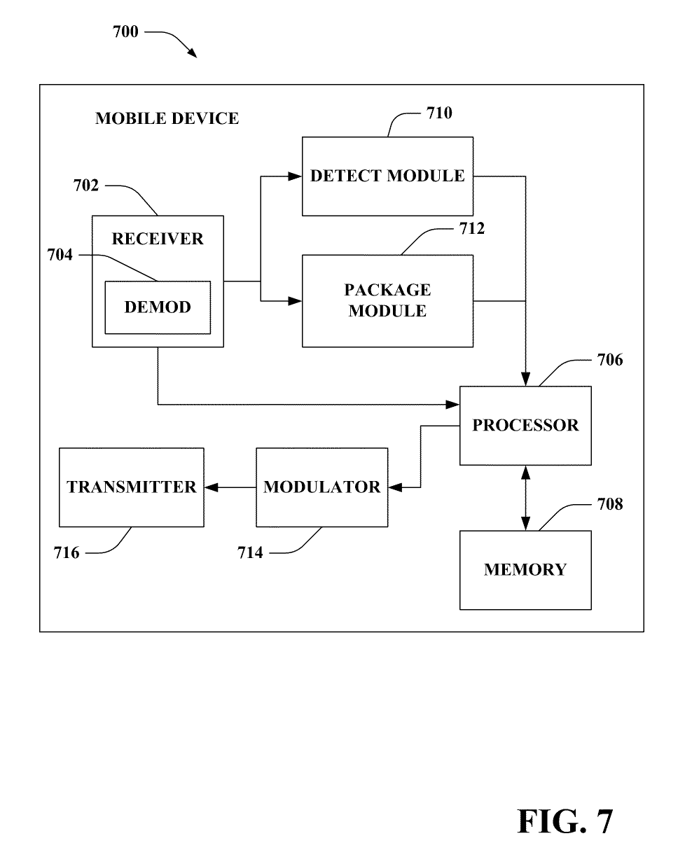

FIG. 7 is an illustration of a mobile device 700 that facilitates creating a packet bundle of two or more IP packets in a wireless communication system. Mobile device 700 comprises a receiver 702 that receives a signal from, for instance, a receive antenna (not shown), performs typical actions on (e.g., filters, amplifies, downconverts, etc.) the received signal, and digitizes the conditioned signal to obtain samples. Receiver 702 can comprise a demodulator 704 that can demodulate received symbols and provide them to a processor 706 for channel estimation. Processor 706 can be a processor dedicated to analyzing information received by receiver 702 and/or generating information for transmission by a transmitter 716, a processor that controls one or more components of mobile device 700, and/or a processor that both analyzes information received by receiver 702, generates information for transmission by transmitter 716, and controls one or more components of mobile device 700.

Mobile device 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.).

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 708 of the subject systems and methods is intended to comprise, without being limited to, these and any other suitable types of memory.

Processor 706 can further be operatively coupled to a detect module 710 and/or a package module 712. The detect module 710 can identify a receipt of an incoming IP packet. The package module 712 can employ a collection and packing technique in which two or more IP packets can be included into a packet bundle. The bundle creation can be implemented upon receipt of the incoming IP packet. Moreover, the package module 712 can create the packet bundle based upon a timer, a maximum number of IP packets within the packet bundle, and/or a maximum size for the packet bundle. Upon creation of the packet bundle (e.g., based on the timer, maximum number of IP packets, and/or the maximum size), the packet bundle can be communicated for JIT processing and/or offline processing.

Mobile device 700 still further comprises a modulator 714 and transmitter 716 that respectively modulate and transmit signals to, for instance, a base station, another mobile device, etc. Although depicted as being separate from the processor 606, it is to be appreciated that the detect module 710, package module 712, demodulator 704, and/or modulator 714 can be part of the processor 706 or multiple processors (not shown).

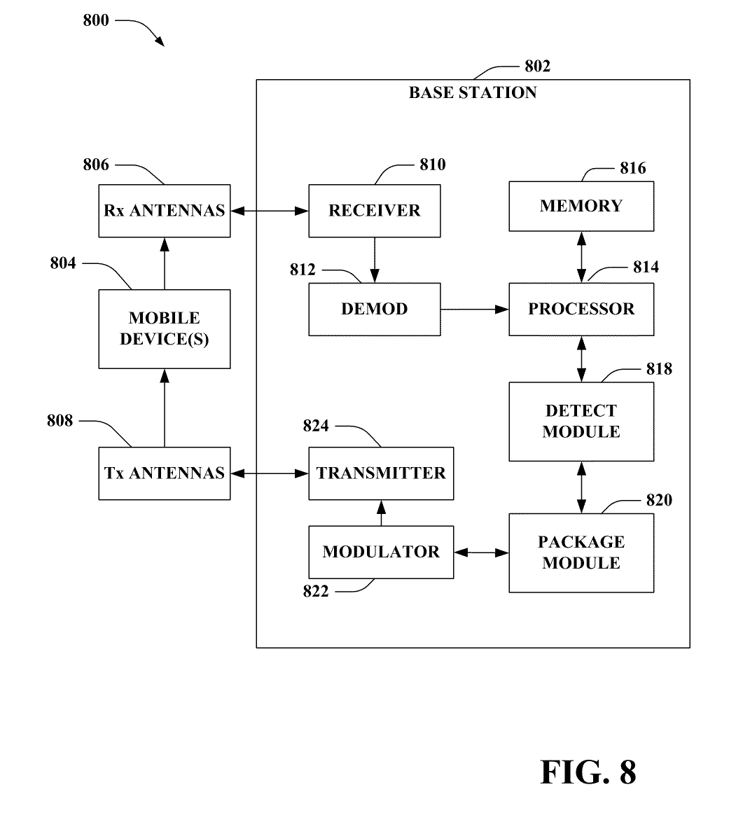

FIG. 8 is an illustration of a system 800 that facilitates employing bundle creation within a wireless communication environment as described supra. The system 800 comprises a base station 802 (e.g., access point, . . . ) with a receiver 810 that receives signal(s) from one or more mobile devices 804 through a plurality of receive antennas 806, and a transmitter 824 that transmits to the one or more mobile devices 804 through a transmit antenna 808. Receiver 810 can receive information from receive antennas 806 and is operatively associated with a demodulator 812 that demodulates received information. Demodulated symbols are analyzed by a processor 814 that can be similar to the processor described above with regard to FIG. 7, and which is coupled to a memory 816 that stores information related to estimating a signal (e.g., pilot) strength and/or interference strength, data to be transmitted to or received from mobile device(s) 804 (or a disparate base station (not shown)), and/or any other suitable information related to performing the various actions and functions set forth herein.

Processor 814 is further coupled to a detect module 818 and/or a package module 820. The detect module 818 can identify a receipt of an incoming IP packet. The package module 820 can employ a collection and packing technique in which two or more IP packets can be included into a packet bundle. The bundle creation can be implemented upon receipt of the incoming IP packet. Moreover, the package module 820 can create the packet bundle based upon a timer, a maximum number of IP packets within the packet bundle, and/or a maximum size for the packet bundle. Upon creation of the packet bundle (e.g., based on the timer, maximum number of IP packets, and/or the maximum size), the packet bundle can be communicated for JIT processing and/or offline processing. Furthermore, although depicted as being separate from the processor 814, it is to be appreciated that the detect module 818, package module 820, demodulator 812, and/or modulator 822 can be part of the processor 814 or multiple processors (not shown).

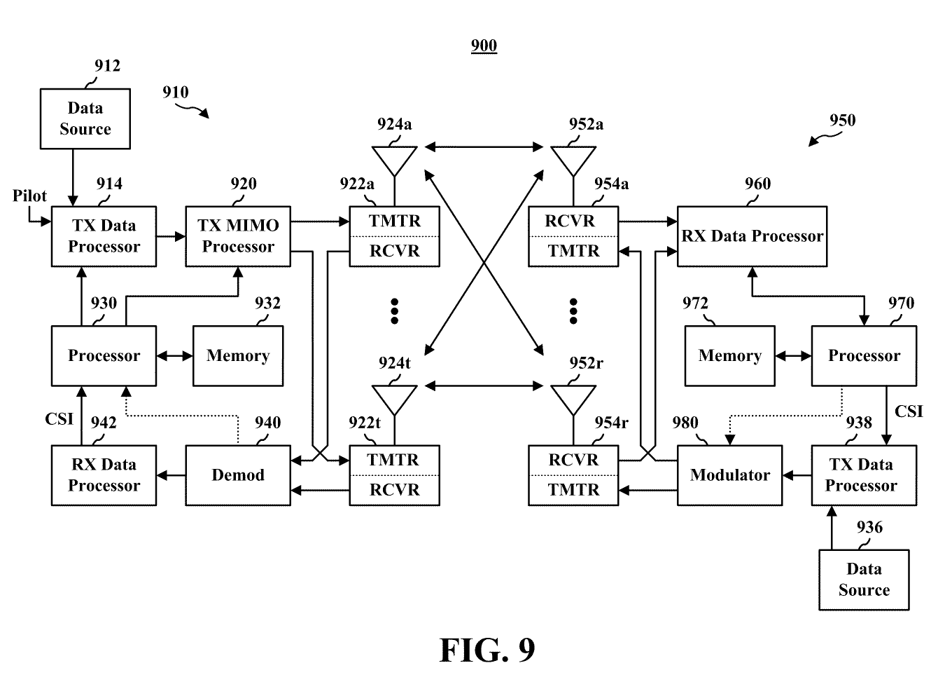

FIG. 9 shows an example wireless communication system 900. The wireless communication system 900 depicts one base station 910 and one mobile device 950 for sake of brevity. However, it is to be appreciated that system 900 can include more than one base station and/or more than one mobile device, wherein additional base stations and/or mobile devices can be substantially similar or different from example base station 910 and mobile device 950 described below. In addition, it is to be appreciated that base station 910 and/or mobile device 950 can employ the systems (FIGS. 1-4 and 7-8) and/or methods (FIGS. 5-6) described herein to facilitate wireless communication there between.

At base station 910, traffic data for a number of data streams is provided from a data source 912 to a transmit (TX) data processor 914. According to an example, each data stream can be transmitted over a respective antenna. TX data processor 914 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 950 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 930.

The modulation symbols for the data streams can be provided to a TX MIMO processor 920, which can further process the modulation symbols (e.g., for OFDM). TX MIMO processor 920 then provides N_{T} modulation symbol streams to N_{T} transmitters (TMTR) 922a through 922t. In various embodiments, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 922a through 922t are transmitted from N_{T} antennas 924a through 924t, respectively.

At mobile device 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective signal, digitizes the conditioned signal to provide samples, and further processes the samples to provide a corresponding “received” symbol stream.

An RX data processor 960 can receive and process the N_{R} received symbol streams from N_{R} receivers 954 based on a particular receiver processing technique to provide N_{T} “detected” symbol streams. RX data processor 960 can demodulate, deinterleave, and decode each detected symbol stream to recover the traffic data for the data stream. The processing by RX data processor 960 is complementary to that performed by TX MIMO processor 920 and TX data processor 914 at base station 910.

A processor 970 can periodically determine which precoding matrix to utilize as discussed above. Further, processor 970 can formulate a reverse link message comprising a matrix index portion and a rank value portion.

The reverse link message can comprise various types of information regarding the communication link and/or the received data stream. The reverse link message can be processed by a TX data processor 938, which also receives traffic data for a number of data streams from a data source 936, modulated by a modulator 980, conditioned by transmitters 954a through 954r, and transmitted back to base station 910.

At base station 910, the modulated signals from mobile device 950 are received by antennas 924, conditioned by receivers 922, demodulated by a demodulator 940, and processed by a RX data processor 942 to extract the reverse link message transmitted by mobile device 950. Further, processor 930 can process the extracted message to determine which precoding matrix to use for determining the beamforming weights.

Processors 930 and 970 can direct (e.g., control, coordinate, manage, etc.) operation at base station 910 and mobile device 950, respectively. Respective processors 930 and 970 can be associated with memory 932 and 972 that store program codes and data. Processors 930 and 970 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

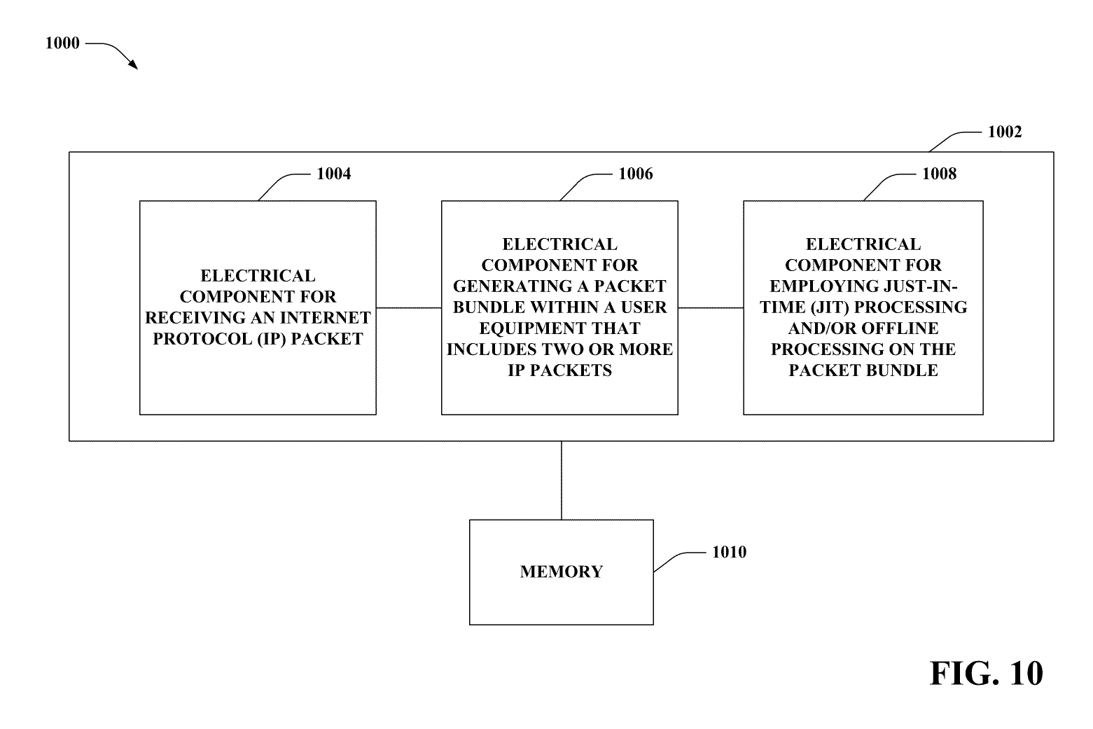

With reference to FIG. 10, illustrated is a system 1000 that packaging IP packets into a packet bundle within a user equipment. For example, system 1000 can reside at least partially within a base station, mobile device, etc. It is to be appreciated that system 1000 is represented as including functional blocks, which can be functional blocks that represent functions implemented by a processor, software, or combination thereof (e.g., firmware). System 1000 includes a logical grouping 1002 of electrical components that can act in conjunction. The logical grouping 1002 can include an electrical component for receiving an Internet Protocol (IP) packet 1004. In addition, the logical grouping 1002 can comprise an electrical component for generating a packet bundle within a user equipment that includes two or more IP packets 1006. Moreover, the logical grouping 1002 can include an electrical component for employing Just-In-Time (JIT) processing and/or offline processing on the packet bundle 1008. Additionally, system 1000 can include a memory 1010 that retains instructions for executing functions associated with electrical components 1004, 1006, and 1008. While shown as being external to memory 1010, it is to be understood that one or more of electrical components 1004, 1006, and 1008 can exist within memory 1010.

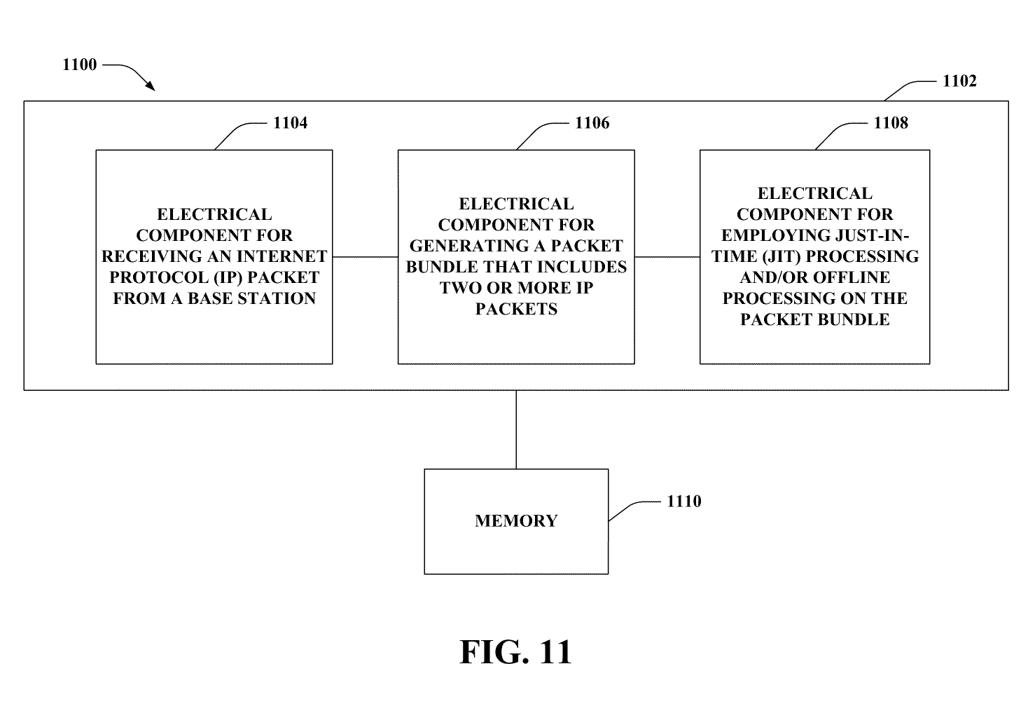

Turning to FIG. 11, illustrated is a system 1100 that identifies IP packets from a base station to bundle based at least in part upon a timer in a wireless communication environment. System 1100 can reside within a base station, mobile device, etc., for instance. As depicted, system 1100 includes functional blocks that can represent functions implemented by a processor, software, or combination thereof (e.g., firmware). System 1100 includes a logical grouping 1102 of electrical components that facilitate evaluating timing adjustments. Logical grouping 1102 can include an electrical component for receiving an Internet Protocol (IP) packet from a base station 1104. Moreover, logical grouping 1102 can include an electrical component for generating a packet bundle that includes two or more IP packets 1106. Further, logical grouping 1102 can comprise an electrical component for employing Just-In-Time (JIT) processing and/or offline processing on the packet bundle 1108. Additionally, system 1100 can include a memory 1110 that retains instructions for executing functions associated with electrical components 1104, 1106, and 1108. While shown as being external to memory 1110, it is to be understood that electrical components 1104, 1106, and 1108 can exist within memory 1110.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method used in a wireless communications system, comprising:
receiving an Internet Protocol (IP) packet;
generating a packet bundle that includes two or more IP packets; and
employing at least one of a Just-In-Time (JIT) processing on the packet bundle or an offline processing on the packet bundle.

2. The method of claim 1, further comprising:
starting a timer upon a receipt of the IP packet;
generating the packet bundle until an expiration of the timer; and
communicating the packet bundle for JIT processing at the expiration of the timer.

3. The method of claim 2, further comprising:
identifying a maximum number of IP packets for the packet bundle;
monitoring a number of IP packets generated within the packet bundle;
generating the packet bundle until the maximum number of IP packets is included within the packet bundle; and
communicating the packet bundle for JIT processing based upon the maximum number of IP packets included within the packet bundle.

4. The method of claim 3, further comprising:
identifying a maximum size for the packet bundle;
monitoring a size of the packet bundle;
generating the packet bundle until the size of the packet bundle is equal to the maximum size for the packet bundle; and
communicating the packet bundle for JIT processing based upon the maximum size for the packet bundle is equal to monitored size.

5. The method of claim 1, further comprising:
identifying a time interval;
generating the packet bundle during the time interval; and
communicating the packet bundle for JIT processing at an expiration of the time interval.

6. The method of claim 5, further comprising:
communicating the packet bundle for JIT processing based upon a maximum number of IP packets generated into the packet bundle; and
communicating the packet bundle for JIT processing based upon detection of a maximum size of the packet bundle.

7. The method of claim 1, further comprising generating the packet bundle at a layer within a Long Term Evolution (LTE) interface, wherein the layer is at least one of a Packet Data Convergence Protocol (PDCP), a Medium Access Control (MAC), or a Radio Link Control (RLC).

8. The method of claim 1, wherein the IP packet is a Packet Data Convergence Protocol Service Data Unit (PDCP SDU) and the JIT processing creates a Medium Access Control (MAC) packet upon receipt of a scheduling request.

9. The method of claim 1, further comprising receiving the IP packet from at least one of a base station, an eNodeB, a NodeB, or a portion of a network.

10. The method of claim 1, further comprising generating the packet bundle within at least one of a network, a portion of a network, a user equipment (UE), or a portion of a user equipment (UE).

11. A wireless communications apparatus, comprising:
at least one processor configured to:
receive an Internet Protocol (IP) packet;
generate a packet bundle that includes two or more IP packets;
employ at least one of a Just-In-Time (JIT) processing on the packet bundle or an offline processing on the packet bundle; and
a memory coupled to the at least one processor.

12. The wireless communications apparatus of claim 11, further comprising at least one processor configured to:
start a timer upon a receipt of the IP packet;
generate the packet bundle until an expiration of the timer; and
communicate the packet bundle for JIT processing at the expiration of the timer.

13. The wireless communications apparatus of claim 12, further comprising at least one processor configured to:
identify a maximum number of IP packets for the packet bundle;
monitor a number of IP packets generated within the packet bundle;
generate the packet bundle until the maximum number of IP packets is included within the packet bundle; and
communicate the packet bundle for JIT processing based upon the maximum number of IP packets included within the packet bundle.

14. The wireless communications apparatus of claim 13, further comprising at least one processor configured to:
identify a maximum size for the packet bundle;
monitor a size of the packet bundle;
generate the packet bundle until the size of the packet bundle is equal to the maximum size for the packet bundle; and
communicate the packet bundle for JIT processing based upon the maximum size for the packet bundle is equal to the monitored size.

15. The wireless communications apparatus of claim 11, further comprising at least one processor configured to:
identify a time interval;
generate the packet bundle during the time interval; and
communicate the packet bundle for JIT processing at an expiration of the time interval.

16. The wireless communications apparatus of claim 15, further comprising at least one processor configured to:
communicate the packet bundle for JIT processing based upon a maximum number of IP packets generated into the packet bundle; and
communicate the packet bundle for JIT processing based upon detection of a maximum size of the packet bundle.

17. The wireless communications apparatus of claim 11, further comprising at least one processor configured to generate the packet bundle at a layer within a Long Term Evolution (LTE) interface, wherein the layer is at least one of a Packet Data Convergence Protocol (PDCP), a Medium Access Control (MAC), or a Radio Link Control (RLC).

18. The wireless communications apparatus of claim 11, wherein the IP packet is a Packet Data Convergence Protocol Service Data Unit (PDCP SDU) and the JIT processing creates a Medium Access Control (MAC) packet upon receipt of a scheduling request.

19. The wireless communications apparatus of claim 11, further comprising at least one processor configured to receive the IP packet from at least one of a base station, an eNodeB, a NodeB, or a portion of a network.

20. The wireless communications apparatus of claim 11, further comprising at least one processor configured to generating the packet bundle within at least one of a network, a portion of a network, a user equipment (UE), or a portion of a user equipment (UE).

21. A wireless communications apparatus, comprising:
means for receiving an Internet Protocol (IP) packet;
means for generating a packet bundle that includes two or more IP packets; and
means for employing at least one of a Just-In-Time (JIT) processing on the packet bundle or an offline processing on the packet bundle.

22. The wireless communications apparatus of claim 21, further comprising:
means for starting a timer upon a receipt of the IP packet;
means for generating the packet bundle until an expiration of the timer; and
means for communicating the packet bundle for JIT processing at the expiration of the timer.

23. The wireless communications apparatus of claim 22, further comprising:
means for identifying a maximum number of IP packets for the packet bundle;
means for monitoring a number of IP packets generated within the packet bundle;
means for generating the packet bundle until the maximum number of IP packets is included within the packet bundle; and
means for communicating the packet bundle for JIT processing based upon the maximum number of IP packets included within the packet bundle.

24. The wireless communications apparatus of claim 23, further comprising:
means for identifying a maximum size for the packet bundle;
means for monitoring a size of the packet bundle;
means for generating the packet bundle until the size of the packet bundle is equal to the maximum size for the packet bundle; and
means for communicating the packet bundle for JIT processing based upon the maximum size for the packet bundle is equal to the monitored size.

25. The wireless communications apparatus of claim 21, further comprising:
means for identifying a time interval;
means for generating the packet bundle during the time interval; and
means for communicating the packet bundle for JIT processing at an expiration of the time interval.

26. The wireless communications apparatus of claim 25, further comprising:
means for communicating the packet bundle for JIT processing based upon a maximum number of IP packets generated into the packet bundle; and
means for communicating the packet bundle for JIT processing based upon detection of a maximum size of the packet bundle.

27. The wireless communications apparatus of claim 21, further comprising means for generating the packet bundle at a layer within a Long Term Evolution (LTE) interface, wherein the layer is at least one of a Packet Data Convergence Protocol (PDCP), a Medium Access Control (MAC), or a Radio Link Control (RLC).

28. The wireless communications apparatus of claim 21, wherein the IP packet is a Packet Data Convergence Protocol Service Data Unit (PDCP SDU) and the JIT processing creates a Medium Access Control (MAC) packet upon receipt of a scheduling request.

29. The wireless communications apparatus of claim 21, further comprising means for receiving the IP packet from at least one of a base station, an eNodeB, a NodeB, or a portion of a network.

30. The wireless communications apparatus of claim 21, further comprising means for generating the packet bundle within at least one of a network, a portion of a network, a user equipment (UE), or a portion of a user equipment (UE).

31. A computer program product, comprising:
a computer-readable medium comprising:
code for causing at least one computer to receive an Internet Protocol (IP) packet;
code for causing at least one computer to generate a packet bundle that includes two or more IP packets;
code for causing at least one computer to employ at least one of a Just-In-Time (JIT) processing on the packet bundle or an offline processing on the packet bundle; and
a memory coupled to the at least one processor.

32. The computer program product of claim 31, further comprising:
a computer-readable medium comprising:
code for causing at least one computer to start a timer upon a receipt of the IP packet;
code for causing at least one computer to generate the packet bundle until an expiration of the timer; and
code for causing at least one computer to communicate the packet bundle for JIT processing at the expiration of the timer.

33. The computer program product of claim 32, further comprising:
a computer-readable medium comprising:
code for causing at least one computer to identify a maximum number of IP packets for the packet bundle;
code for causing at least one computer to monitor a number of IP packets generated within the packet bundle;
code for causing at least one computer to generate the packet bundle until the maximum number of IP packets is included within the packet bundle; and
code for causing at least one computer to communicate the packet bundle for JIT processing based upon the maximum number of IP packets included within the packet bundle.

34. The computer program product of claim 33, further comprising:
a computer-readable medium comprising:
code for causing at least one computer to identify a maximum size for the packet bundle;
code for causing at least one computer to monitor a size of the packet bundle;
code for causing at least one computer to generate the packet bundle until the size of the packet bundle is equal to the maximum size for the packet bundle; and
code for causing at least one computer to communicate the packet bundle for JIT processing based upon the maximum size for the packet bundle is equal to the monitored size.

35. The computer program product of claim 31, further comprising:
a computer-readable medium comprising:
code for causing at least one computer to identify a time interval;
code for causing at least one computer to generate the packet bundle during the time interval; and
code for causing at least one computer to communicate the packet bundle for JIT processing at an expiration of the time interval.

36. The computer program product of claim 35, further comprising:
a computer-readable medium comprising:
code for causing at least one computer to communicate the packet bundle for JIT processing based upon a maximum number of IP packets generated into the packet bundle; and
code for causing at least one computer to communicate the packet bundle for JIT processing based upon detection of a maximum size of the packet bundle.

37. The computer program product of claim 31, further comprising:
a computer-readable medium comprising:
code for causing at least one computer to generate the packet bundle at a layer within a Long Term Evolution (LTE) interface, wherein the layer is at least one of a Packet Data Convergence Protocol (PDCP), a Medium Access Control (MAC), or a Radio Link Control (RLC).

38. The computer program product of claim 31, wherein the IP packet is a Packet Data Convergence Protocol Service Data Unit (PDCP SDU) and the JIT processing creates a Medium Access Control (MAC) packet upon receipt of a scheduling request.

39. The computer program product of claim 31, further comprising:
a computer-readable medium comprising:
code for causing at least one computer to receive the IP packet from at least one of a base station, an eNodeB, a NodeB, or a portion of a network.

40. The computer program product of claim 31, further comprising:
a computer-readable medium comprising:
code for causing at least one computer to generate the packet bundle within at least one of a network, a portion of a network, a user equipment (UE), or a portion of a user equipment (UE).
